(19) United States
(12) Patent Application Publication
(10) Pub. No.: US 2006/0166547 A1
(43) Pub. Date: Jul. 27, 2006

(54) Electric contact element for a flat conductor

(76) Inventors: Stefan Deutmarg, Hann (DE); Achim Pottmann, Wuppertal (DE); Andreas Langenberg, Wuppertal (DE); Bernd Zinn, Ennepetal (DE)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 11/229,309

(22) Filed: Sep. 16, 2005

Related U.S. Application Data
(63) Continuation of application No. PCT/DE04/00513, filed on Mar. 13, 2004.

(30) Foreign Application Priority Data
Mar. 17, 2003 (DE) 203 04 328.6
Feb. 18, 2004 (DE) 20 2004 002 739.9

(51) Int. Cl. H01R 11/20

(52) U.S. Cl. 439/422

(57) ABSTRACT

Electric contact element made of a sheet metal stamped part having a fit-on region for fitting to a conductor track of a flat conductor, the fit-on region having a planar base plate and a spring arm with locking arms at a distance above the base plate, and contact tongues being provided which penetrate the insulation material of the flat conductor during fitting, advance as far as the conductor track, scrape along the conductor track and establish contact, and method for producing the electric contact element. The contact tongues and at least one locking arm are attached to the longitudinal edges of the spring arm.

The invention relates to an electric contact element made of a sheet metal stamped part for making contact with a conductor track of a flat conductor. The invention furthermore relates to the use of the contact element in a plug connector housing.

A contact element of the generic type is known from DE-A 1 615 654. The known contact element has a crimp region, by means of which the contact element is crimped onto a conductor track of a flat conductor, said conductor track being arranged in a strip-type insulating material and running parallel to other conductor tracks. The crimp region is cross-sectionally U-shaped or fluted and has a rectangular base plate to whose longitudinal side edges side walls serving as crimp claws are attached and bent up. Two teeth that are arranged one behind the other in the longitudinal direction, are directed relative to one another and raised with respect to the interior space of the crimp region are cut free in the base plate. In order to fit the crimp region to a conductor track of a flat conductor, the side walls pierce the insulation material in the longitudinal edge region of a conductor track and are subsequently rolled up to form the crimp, the free side wall upper edges penetrating the insulation material above the conductor track and making contact with the conductor track from above. At the same time, the teeth penetrate the insulation material of the flat conductor from below and likewise make contact with the conductor track.

The known contact element requires a considerable outlay on crimping. Moreover, it cannot be ensured that the conductor track is not severed by the sharp edges of the side walls and the teeth after penetration of the insulation material. Severing of the conductor track would at least effect a deficient contact connection.

DE-A 25 44 893 discloses another contact-making technique for a flat conductor, in which insulation material is scraped off by means of contact arms. The fit-on region of this known contact element has a planar base plate to whose longitudinal edges side wall webs are attached and angled away, thereby forming a channel that is U-shaped in cross section. Between the side wall webs, contact fingers pointing in an opposite direction in the base plate are cut through and raised into the interior space of the channel, the fingers pointing in the direction of the side walls.

In order to make contact with a conductor track of a flat conductor, the flat conductor is arranged above the fit-on region and a first tool is used such that the insulation material of the flat conductor is pierced laterally beside a conductor track with the side wall webs. The side wall webs are bent inward by means of a second tool until they are situated above the surface of the flat conductor. In this case, the contact fingers penetrate into the insulation material. The side wall webs are brought to bear on the flat conductor by means of a third tool. At the same time, the contact fingers are bent downward, in which case they scrape off the insulation material of the flat conductor and uncover and make contact with the conductor track. The side wall webs function as locking arms that prevent the contact fingers from springing back.

What is disadvantageous about this contact element, too, is that the fitting is very complicated and requires three different tools. Moreover the scraping edges of the contact fingers are situated relatively far away from the longitudinal centre of the base plate and can only uncover a relatively short section of the conductor track. Different configurations would therefore have to be provided for conductor tracks of different widths. What is more, the locking arms or the side wall webs bear on the insulation material, which yields over time, and accordingly, do not effect sufficiently rigid locking. The required contact pressure of the contact fingers at the contact locations may thereby be impaired and the contact connection may deteriorate.

DE 27 07 093 C2 describes contact elements for making contact with a flat conductor, which are inserted into a plug connector housing prior to fitting and are fitted, at the same time or in one work operation using a fit-on tool, to a flat conductor inserted into the housing. The fit-on region of this contact element is formed in multilayered fashion and has two layers fitted on one another and a clip arm attached, at a distance above the upper layer of the layers fitted on one another, to the upper layer in the rear region thereof in one piece by means of a V-shaped bent-off portion. In the upper layer, two contact teeth extending in an opposite direction are cut free and raised one behind the other in the longitudinal direction of the contact region. Moreover, on the clip arm above the contact teeth of the upper layer, crimp arms pointing in the direction of the contact teeth of the upper layer are likewise arranged one behind the other in the longitudinal direction.

For fitting, the clip arms of the contact elements inserted into the clip connector housing, with the lid of the housing open, are moved, by an upper punch tool of a crimp device, against a lower punch tool of the crimp device reaching through a corresponding opening in the plug connector housing. In this case, the crimp arms penetrate the insulation material and the conductor track of the flat conductor and are rolled up, in which case they finally reach under the upper layer. At the same time as the crimping, the contact teeth of the upper layer are pressed from below through the insulation material right onto the conductor track; they then scrape along the undersurface of the conductor track and scrape off insulation material. A plurality of pressure contact locations per contact element are intended to be created in this way.

What is disadvantageous about this simultaneous multiple contact connection of a flat conductor is that, in this case as well, the conductor tracks are not only pierced by crimp arms but may also be severed, which may result in defective contact connection.

It is an object of the invention to provide an electric contact element made of a sheet metal stamped part for making contact with a flat conductor which enables simple effective contact connection unchanged in the long term without piercing the conductor track and such that the contact element is suitable for multiple contact connection in a plug connector housing.

This object is achieved by means of the features of claim 1. Advantageous developments of the invention are characterized in the subclaims. The invention is explained in more detail below by way of example with reference to the drawing, in which:

FIG. 1 shows a perspective view on the top side of a first embodiment of a contact element according to the invention from the front;

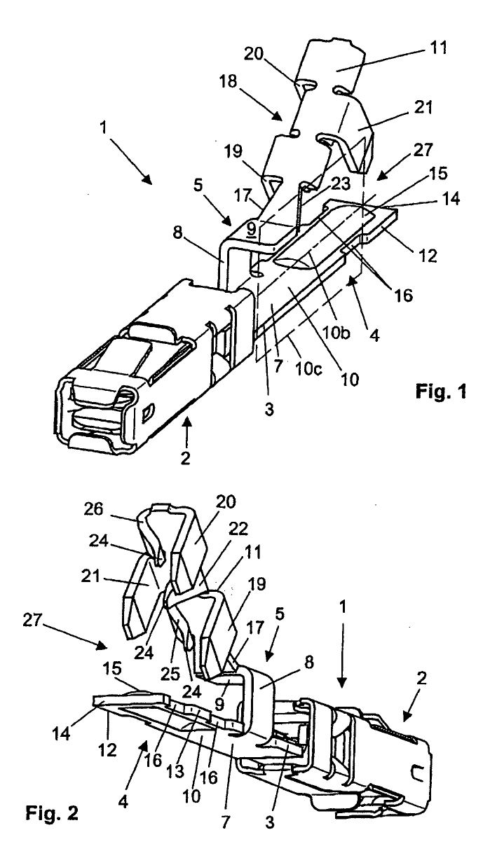

FIG. 2 shows a perspective view at the underside of the contact element according to FIG. 1 from the rear;

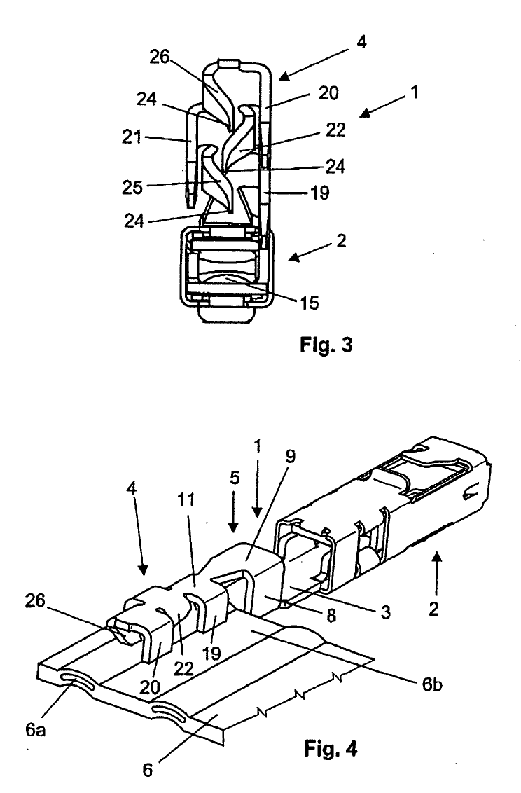

FIG. 3 shows a contact element according to FIG. 1 from the rear;

FIG. 4 shows a perspective view on the top side of the contact element according to FIG. 1, fitted to a flat conductor, from the rear;

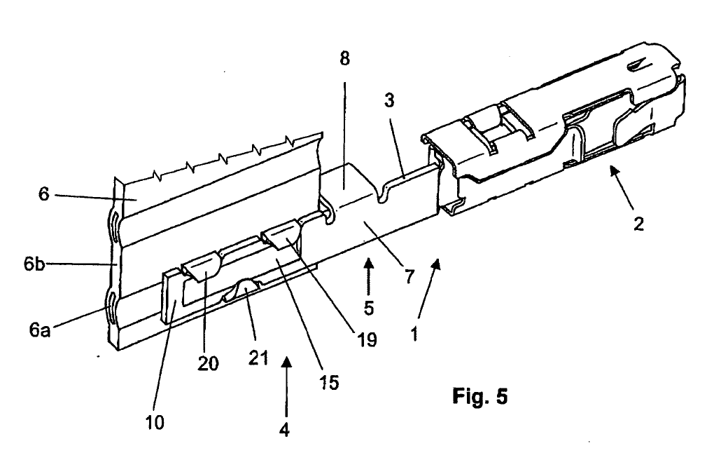

FIG. 5 shows a perspective view at the underside of the contact element according to FIG. 4;

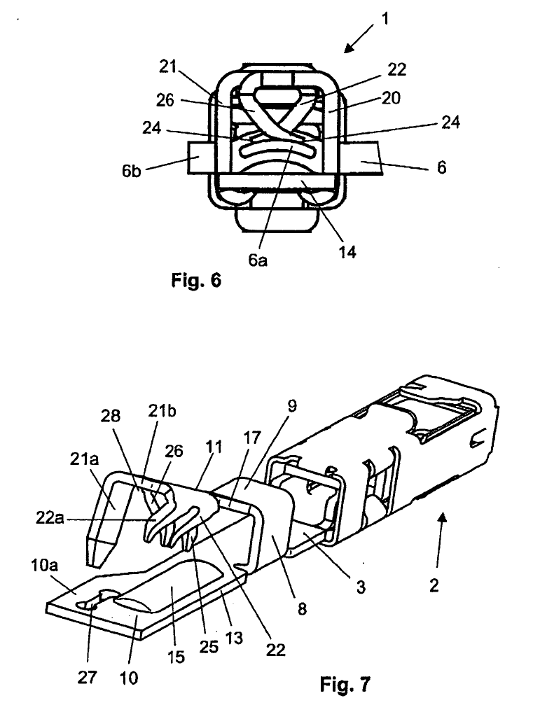

FIG. 6 schematically shows a rear view of the fitted contact element according to FIG. 4;

FIG. 7 shows a perspective view on the top side of a second embodiment of a contact element according to the invention from the rear;

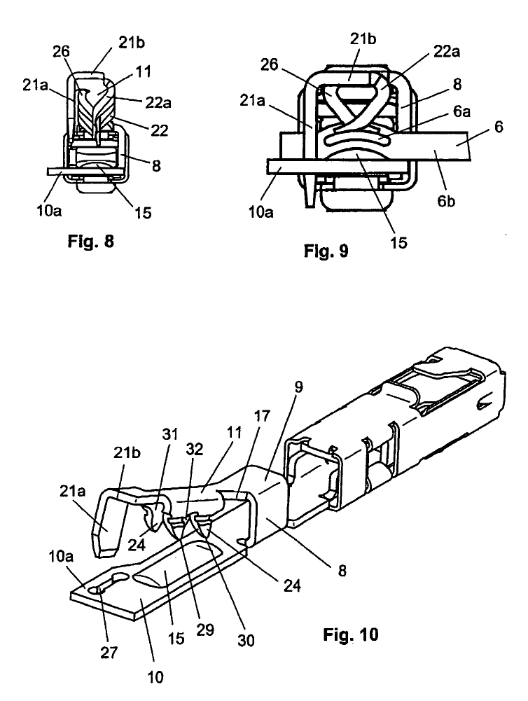

FIG. 8 shows a rear view of the contact element according to FIG. 7;

FIG. 9 schematically shows a rear view of the fitted contact element according to FIG. 7;

FIG. 10 shows a perspective view on the top side of a third embodiment of a contact element according to the invention from the rear;

FIG. 11 schematically shows a rear view of the fitted contact element according to FIG. 10;

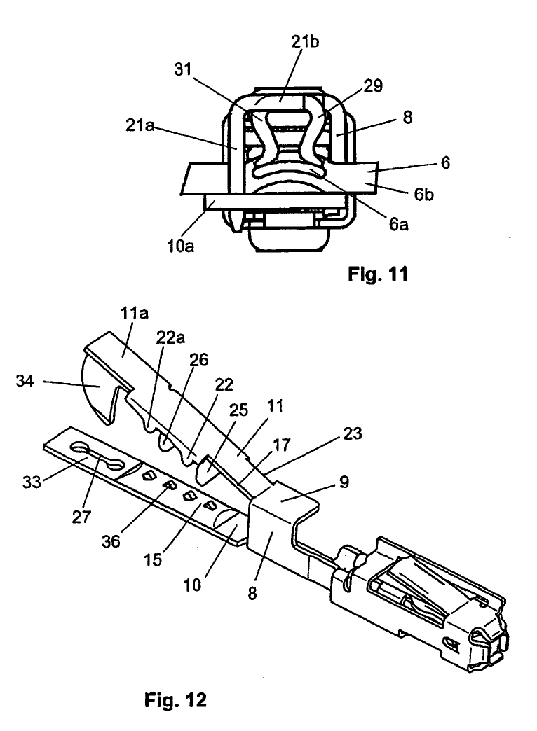

FIG. 12 shows a perspective view from the top side of a fourth embodiment of a contact element according to the invention from the front;

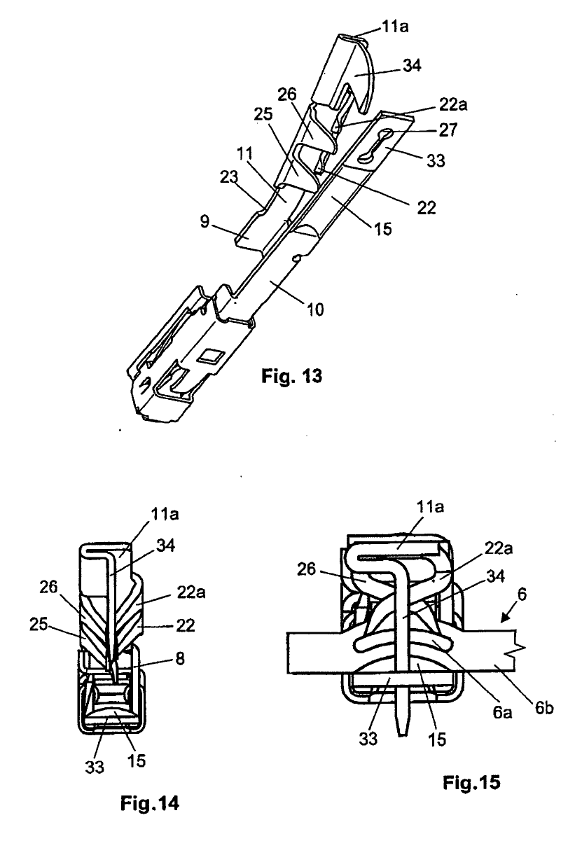

FIG. 13 shows a perspective view at the underside of the contact element according to FIG. 12 from the rear;

FIG. 14 shows a rear view of the contact element according to FIG. 12;

FIG. 15 schematically shows a rear view of the fitted contact element according to FIG. 12;

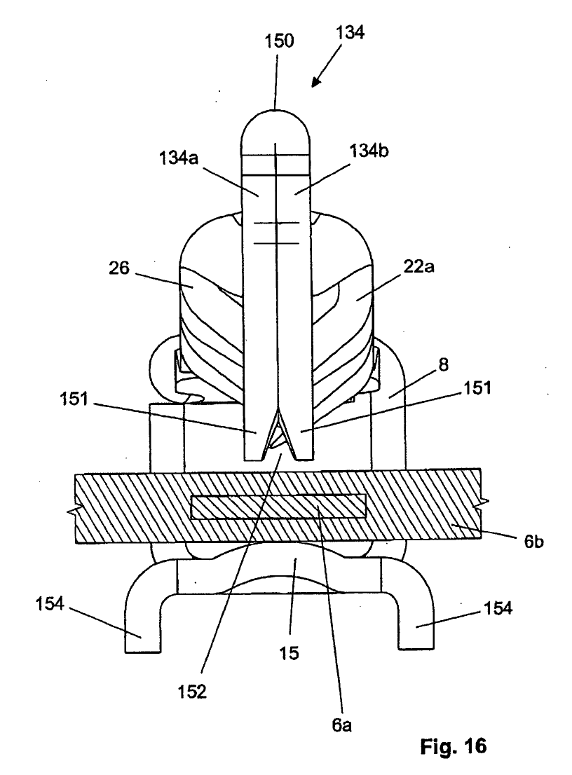

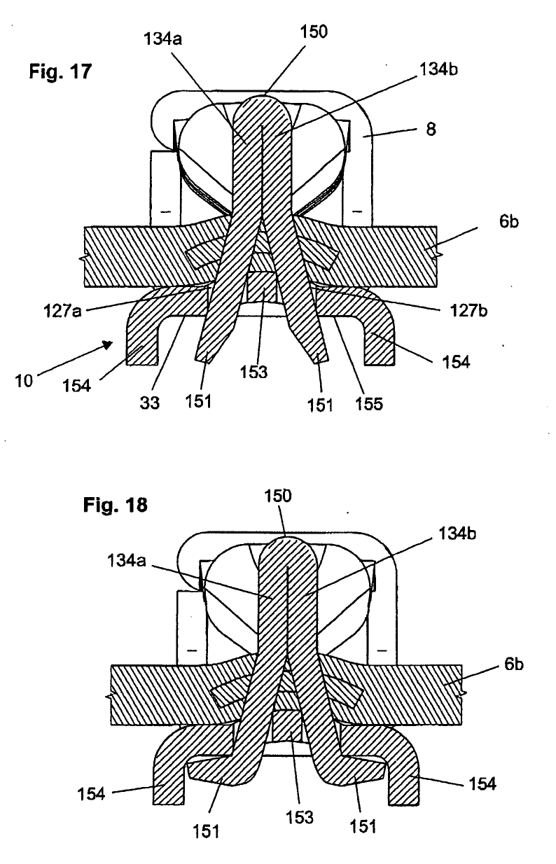

FIGS. 16 to 18 show a rear view of a fifth embodiment of a contact element according to the invention in an initial position (FIG. 16), an intermediate position cut away partly in regions (FIG. 17), and the locking position, cut away partly in regions (FIG. 18).

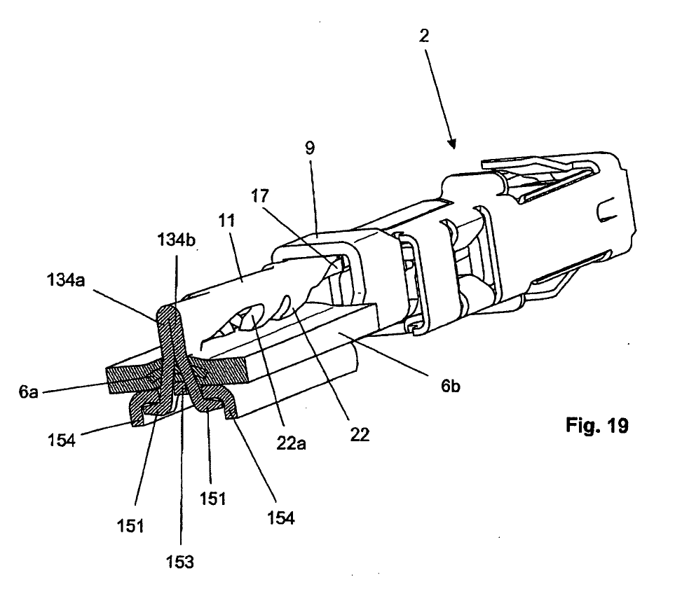

FIG. 19 shows a perspective rear view of the fifth embodiment according to FIGS. 16 to 18 cut away partly in regions;

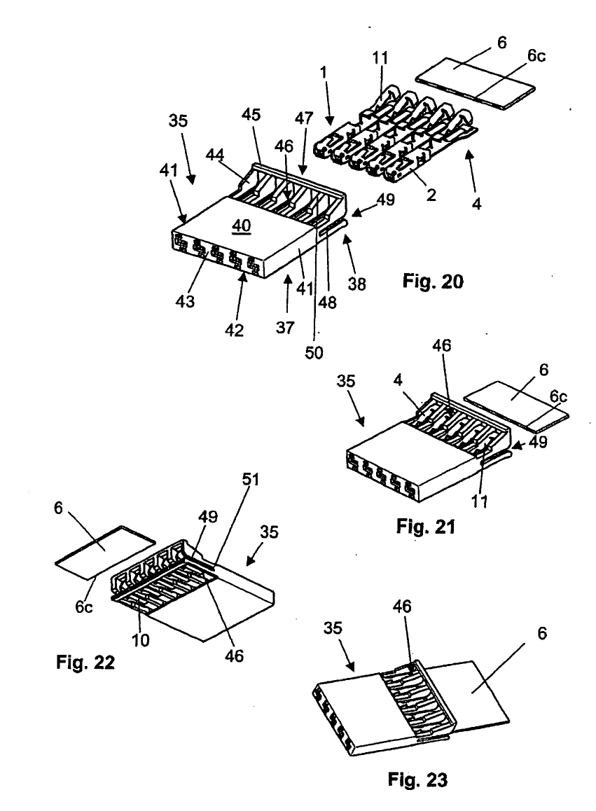

FIG. 20 shows a perspective exploded illustration of a plug connector housing according to the invention;

FIG. 21 shows a perspective view of the plug connector housing according to FIG. 20 with inserted contact elements from above;

FIG. 22 shows a perspective view of the plug connector housing according to FIG. 20 with inserted contact elements from below;

FIG. 23 shows a perspective view of the plug connector housing according to FIG. 20 with a fitted flat conductor from above.

The contact element 1 according to the invention made of a sheet metal stamped part according to FIGS. 1 to 6 has, one behind the other in the longitudinal direction, a contact part 2 for e.g. a mating contact element (not illustrated), a transition region 3 and a fit-on region 4 for fitting a flat conductor 6. The contact region 2, which is illustrated as a contact sleeve for example, may be formed as desired, e.g. also as a contact pin, soldering lug or the like. The transition region 3, which is a planar web in the example illustrated, may likewise be configured as desired.

The fit-on region 4, in which the invention is realized, is attached to the transition region 3 in a manner extending toward the rear and has, in this exemplary embodiment, a cross-sectionally C-shaped spring arm base region 5 with a bottom web 7 in continuation of the transition web 3, a side wall web 8 angled away at right angles, and a cover web 9 angled away at right angles therefrom.

Attached to the bottom web 7 is a rectangular base plate 10 extending toward the rear and attached to the cover wall 9 is a spring arm 11 of approximately identical length, which extends at a distance above the base plate 10. The base plate 10 is bounded by the two longitudinal edges 12, 13 and the rear edge 14. A longitudinal bead 15 extending parallel to the longitudinal side edges 12, 13 in the longitudinal direction of the base plate is pressed into the base plate 10 from below, said longitudinal bead curving upward in the direction of the spring arm 11. The zenith of the longitudinal bead 15 expediently runs parallel above the longitudinal central line 10b, which is illustrated in a dash-dotted manner in FIG. 1, or in the longitudinal central plane 10c (illustrated in a dashed manner in FIG. 1), perpendicular to the base plate 10.

Cutouts 16 are introduced into the longitudinal side edges 12, 13, the purpose of said cutouts being explained further below.

The spring arm 11 has, on one longitudinal edge 17 arranged above the longitudinal edge 13 of the base plate 10, two locking arms 19, 20 that are arranged at a distance with a gap 18 and are angled away approximately at right angles in the direction of the longitudinal edge 13, and, on the other longitudinal edge 23 in a manner lying opposite the gap 18 and above the longitudinal edge 12 of the base plate 10, a locking arm 21 that is angled away approximately at right angles downward in the direction of the longitudinal edge 12.

In the gap 18 between the locking arms 19, 20, a contact tongue 22 angled away e.g. through 90°, in particular through 100° in the direction of the base plate 10 and longitudinal central plane 10c, is attached to the longitudinal edge 17, the free end region of which is formed as a tip 24 which is e.g. rounded, preferably strengthened by embossing and embossed more thinly, and is somewhat bent back or embossed back. Two identical contact tongues 25, 26 are in each case attached to the longitudinal edge 23 alongside the locking arm 21. Accordingly, the contact tongue 22 lies opposite the gap between the contact tongues 25, 26. What is essential is that the contact tongues 22, 25, 26 are in each case bent away from their attachment side toward the opposite side, and that at least the tips 24 are positioned beyond the longitudinal central plane 10c on the respective other side of the longitudinal central plane 10c.

According to the invention, the spring arm 11 is bent away from the plane of the cover wall 9 at an acute angle upward in a manner directed away from the base plate 10, so that an insertion depth 27 for the insertion of a flat conductor 6 is formed from the rear edge 14 as far as the spring arm base region 5.

The angling away of the contact tongues 22, 25 and 26 through approximately 100° can be discerned from FIG. 3. Its purpose is to position the tips 24 in the region above and on the other side of the zenith of the curvature, that is to say across the zenith line in the direction toward the respective other sloping side of the bead 15.

The spatial forms chosen for the elements for the fit-on region 4 lead to contact being established with a conductor track 6a of a flat conductor 6 in accordance with FIGS. 4, 5 and 6. By means of suitable tools (not illustrated), the locking arms 19, 20, 21 are pushed through the insulation material 6b, passed through the cutouts 16 of the base plate 10 and are preferably bent over under the base plate 10 and pressed against the base plate 10 (FIG. 5).

During this, the tips 24 of the contact tongues 22, 25, 26 impinge on the insulation material 6b above the conductor track 6a of the flat conductor 6, which is correspondingly curved in a manner bearing on the bead 15. The tips 24 penetrate into the insulation material 6b and advance as far as the conductor track 6a, scrape on the flanks of the curvature of the conductor track, relative in each case to the attachment edge of the contact tongues, in the direction toward the opposite longitudinal edge of the conductor track 6a or the base plate 10 (FIG. 6), and bear on the conductor track in a manner that establishes contact or sink somewhat into the surface region. In this case, contact tongues 25, 26 cross the contact tongue 22 (FIG. 6). The contact tongues do not impede one another during fitting since the contact tongue 22 is not arranged opposite either of the two contact tongues 25, 26. The contact tongues 22, 25, 26 generate a high contact pressure because the contact tongues endeavor to spring back, as a result of the locking of the locking arms 19, 20, 21 supported on the base plate 10, but are prevented from doing so. This high contact pressure is impaired neither by material fatigue nor by externally applied vibrations.

The contact element according to FIG. 7, 8 or 9 essentially corresponds to the contact element according to FIGS. 1 to 6. What is different is that only one locking arm 21a is attached to the side edge 23 in the region of the rear edge 21b of the spring arm 11. Below the locking arm 21a, the base plate 10 has a widening 10a with an elongated hole 27 positioned in such a way that the locking arm 21a can pass through the hole 27 when the spring arm 11 is depressed.

Furthermore, a further contact tongue 22a is attached to the longitudinal edge 17 of the spring arm 11 and is arranged opposite a gap 28 between the contact tongue 26 and the locking arm 21a. Accordingly, the contact tongues can cross one another in an unimpeded manner during fitting in the case of this example as well (FIG. 9).

During fitting, the locking arm 21a is guided through the elongated hole 27 and locked in place and locks the fit-on region e.g. by friction in the elongated hole 27. That region of the locking arm 21a which projects downward via the elongated hole 27 can also be bent over, however. Moreover, the locking may also be ensured by rotating the projecting region or by staking or the like, so that the locking arm 21a can no longer scrape upward out of the elongated hole 27.

One variant of the embodiment of the contact element according to the invention according to FIGS. 7, 8 and 9 can be discerned in FIGS. 10 and 11. Instead of contact tongues that cross during fitting, two contact tongues 29, 30 and 31, 32 are attached in each case in an adjacent manner on each side of the spring arm 11, which contact tongues are initially likewise angled away somewhat toward the longitudinal central plane 10c or toward the zenith of the curvature of the bead 15, but their tip regions 24 are formed such that they are bent back or embossed back away from the longitudinal central plane 10c again, so that the contact tongues run approximately in S-shaped fashion and their tip regions 24 impinge on the curvature of the conductor track 6a on this side of the zenith during fitting and scrape on the conductor track to the longitudinal edge on this side of the conductor track, if appropriate sink in somewhat and establish contact (FIG. 1). In this embodiment, the contact tongues 29, 30 and 31, 32 may be arranged gapwise at the respective longitudinal edge 17, 23 of the spring arm 11 likewise or else in a manner lying opposite.

A further highly expedient variant of the embodiment of the contact element according to the invention according to FIGS. 7, 8 and 9 emerges from FIGS. 12, 13, 14 and 15. Instead of a lateral widening, a rear lengthening 33 of the base plate 10 is provided, into which the elongated hole 27 is introduced into the region of its longitudinal central line 10b. A locking arm 34 is arranged above the elongated hole 27 in the longitudinal central plane 10c, which locking arm, attached to a lengthening 11a of the spring arm 11 at the longitudinal edge 23, is pulled back by 180° in the direction of the longitudinal edge 17 and is bent away downward at right angles approximately in the transverse centre of the lengthening 11a, so that it is positioned above the elongated hole 27. After fitting, the locking arm 34 reaches through the elongated hole 27 (FIG. 15) either in clamping fashion or it is staked or bent over or the like, like the locking arm 21a of the embodiment according to FIGS. 7 to 9.

The advantage of this locking with the locking arm 34 is that a further contact location is created since the locking arm 34 penetrates the conductor track 6a in a manner that establishes contact (FIG. 15), to be precise in the longitudinal direction and not in the transverse direction of the conductor track 6a, so that the risk of the conductor track being severed need not be feared.

A particularly advantageous modification in particular of the contact element illustrated in FIGS. 12 to 15 emerges from FIGS. 16, 17, 18 and 19, the modification relating to the locking arm 134, which likewise corresponds with an elongated hole 27 in accordance with FIGS. 12 to 15 (not illustrated) or two laterally adjacent elongated holes 127a, 127b spaced apart from one another by a material web 153.

The locking arm 134 comprises two locking tongues 134a, 134b which are fitted on one another in the longitudinal central plane 10c and the free ends 151 of which, in the initial position (FIG. 16) are arranged above the elongated hole 27 or respectively above one of the twin elongated holes 127a, 127b. The locking tongues 134a, 134b merge with one another in a bending edge 150, which is attached as rear lengthening 11a to the spring arm 11 in the longitudinal central plane 10c.

The free ends 151 of the locking tongues 134a, 134b are expediently chamfered beside the longitudinal central plane 10c, thereby forming a lead-in funnel 152 in which e.g. a tool or the material web 153 can engage.

FIGS. 17 and 18 illustrate the locking process when the contact element is fitted to the flat conductor 6. The locking tongues 134a, 134b firstly penetrate the flat conductor 6. The material web 153 then passes into the lead-in funnel 152, and leads the free ends 151 of the locking tongues 134a, 134b into and through the respectively assigned elongated hole 127a, 127b until the free ends 151 project by a portion under the lengthening 33 of the base plate 10 (FIG. 17). Afterward, the free ends 151 are preferably angled away outward and pressed against the underside 155 of the lengthening 33 of the base plate 10 (FIG. 18).

It is expedient if the longitudinal edges 154 of the lengthening 33 of the base plate 10 are e.g.—as depicted—angled away downward at right angles, so that the bent-over free ends 151 are laterally covered (FIG. 18).

It may also be advantageous for the contact element 1 to be fitted to a flat conductor 6 which has prestamped perforations or holes for the locking arms 19, 20, 21, 21a, 34, 134 to reach through. Moreover, the conductor cross-section of the conductor track can be reduced in a defined manner, so that a type of fuse element is formed which reacts or fuses in the event of current overloading.

Pointed projections 36 are expediently provided (FIG. 12) on the surface of the bead 15, in particular along its zenith in regions in which the contact tongues do not scrape, which projections press into the insulation material 6a and hold the insulation material fixed during scraping and later prevent it from creeping and absorb the amount of shrinkage. The pointed projections 36 simultaneously serve for immobilizing the flat conductor 6 in the horizontal and vertical directions.

The contact element 1 according to the invention is designed such that it is suitable for multiple contact connection with a flat conductor 6 in a plug connector housing 35 (FIGS. 20 to 23). For this purpose, too, the spring arm 11 is angled away upward, as described.

The essentially parallelepipedal plug connector housing 35 has a chamber region 37 and a contact-making region 38. The contact regions 2 are mounted in the chamber region 37 and the fit-on regions 4 of a contact element 1 are mounted in the contact-making region 38. The chamber region 37 has a cover wall 40, two side walls 41, a bottom wall 42 and a plug-in face 43 at the end.

The contact-making region has chamber webs 44 which are arranged at a distance from one another parallel to the side walls 41 and form a continuation of chamber walls (not illustrated) correspondingly arranged in the chamber region 47 and form upwardly and downwardly opened fit-on shafts 46. The chamber webs 44 are interconnected at the rear side or at the end and on the top side by means of a cross bar 45. The fit-on regions 4 of the contact elements 1 are seated in the fit-on shafts 46.

A slot 48 extending from the rear side 47 as far as the chamber 37 is in each case introduced into the chamber webs 44, so that the slots 48 form a free plug-in gap 49 in the contact-making region 38 for a flat conductor 6. Said plug-in gap 49 is situated in the region of the insertion gap 27 of the connection regions 4 of the contact elements 1.

The chamber webs 44 are expediently formed in approximately triangular fashion as viewed from the side and have an upper edge 50 rising from the chamber region 37 to the rear side 47, the bevel of the upper edge 50 corresponding to the angle of the angling away of the spring arms. In this way, the fit-on regions 4 of the contact elements 1 are not only covered laterally, but also do not project beyond the chamber webs 44 or from the shafts 46 at the top and bottom.

The contact elements 1 are inserted such that they are latched captively in a manner known per se in the chambers of the plug connector housing 35 (FIGS. 21, 22), so that the pre-equipped plug connector housing 35 can be supplied or handled in a manner preassembled with contact elements 1. For fitting, it is merely necessary to push the flat conductor 6 by a free end edge 6c into the plug-in slot 49 and to press the spring arms 11, by means of a fit-on tool (not illustrated) that descends into the shafts 46 from above, downwardly against the base plates 10 supported on an abutment of the fit-on tool (not illustrated) projecting into the shafts 46 from below. It is possible for this to use a fit-on tool which effects the fitting simultaneously en bloc, or a fit-on tool which carries out the fitting individually in succession. In any event this multiple contact connection can be performed very precisely and effectively using simple fit-on means.

A flat conductor having prestamped holes or perforations for the locking arms, in particular the locking arm 34, to reach through is expediently used for fitting. In the case of prestamping the hole in the flat conductor for the locking arm 34, it is possible to create a predetermined fuse element.

What is also advantageous about the contact elements according to the invention is, in particular, that the locking arms also function as strain relief means.

It lies within the scope of the invention to provide, instead of the bead, a planar base plate 10 or a base plate with concave-arcuate transverse grooves or convex-arcuate transverse arcs or trapezoidal transverse arcs.

According to a particular embodiment of the invention, the contact tongues are dispensed with. In this case, the spring arm is merely equipped with locking arms (134), to be precise with at least two, preferably three, locking arms (134) which ensure both anchoring and contact connection. For the rest, the configuration of the base plate preferably corresponds to the configuration already described with reference to FIGS. 16 to 19.

1. Electric contact element made of a sheet metal stamped part at least having a contact part and a fit-on region for fitting the contact element to a conductor track of a flat conductor, the fit-on region having a planar base plate and a spring arm with locking arms at a distance above the base plate, and contact tongues being provided which penetrate the insulation material of the flat conductor during fitting, advance as far as the conductor track, scrape along the conductor track and establish contact, wherein the contact tongues and at least one locking arm are attached to the longitudinal edges of the spring arm.

2. The contact element as claimed in claim 1, wherein the contact tongues are bent away through 90° in the direction of the longitudinal central plane of the base plate.

3. The contact element as claimed in claim 2, wherein tip regions of the contact tongues are in each case arranged on the other side of the longitudinal central plane.

4. The contact element as claimed in claim 2, wherein tip regions of the contact tongues are bent back before the longitudinal central plane.

5. The contact element as claimed in claim 1, wherein the locking arms are bent away by 90° in the direction of the base plate.

6. The contact element as claimed in claim 1, wherein the contact tongues are arranged gapwise on the respective longitudinal edge of the spring arm and the contact tongues of one longitudinal edge are attached in a manner respectively lying opposite a gap of the other longitudinal edge.

7. The contact element as claimed in claim 6, wherein a locking arm is attached in at least one gap.

8. The contact element as claimed in claim 1, wherein a locking arm is arranged at the end of the spring arm.

9. The contact element as claimed in claim 8, wherein there is introduced below the end-side locking arm in a widening of the base plate an elongated hole for the locking arm to reach through.

10. The contact element as claimed in claim 8, wherein the locking arm, in the region of the longitudinal central plane of the base plate, is arranged in a manner extending in the longitudinal central plane and, below the locking arm, provision is made of an elongated hole in the base plate for the locking arm to reach through.

11-16. (canceled)

17. The contact element as claimed in claim 1, wherein a longitudinal bead curved in the direction of the spring arm is introduced into the base plate, the zenith line of said longitudinal bead lying in the region of the longitudinal central plane of the base plate.

18. (canceled)

19. The contact element as claimed in claim 1, wherein the spring arm, at its attachment location, is bent away from a plane, which extends parallel to the plane of the base plate at an acute angle in a manner directed away from the base plate, thereby forming between the base plate and the spring arm a free insertion gap under the ends of the locking arms and contact tongues for the insertion of a flat conductor.

20. The contact element as claimed in claim 1, wherein a spring arm base region is arranged between the contact part and the fit-on region.

21. (canceled)

22. The contact element as claimed in claim 1, wherein it is fitted to a flat conductor, a first portion of the contact tongues crossing a second portion of the contact tongues, penetrating insulation material and establishing contact at the surface of a conductor track and in a manner sunk somewhat in the material in the surface region of the conductor track.

23. The contact element as claimed in claim 1, wherein it is fitted to a flat conductor, the contact tongues on one side and the contact tongues on the other side of the conductor track, in a manner penetrating insulation material, establishing contact at the surface of a conductor track and in a manner sunk somewhat in the surface region.

24-30. (canceled)

31. The contact element as claimed in claim 1, wherein it is seated with a plurality of preferably identical contact elements in a row one beside the other in a plug connector housing, the plug connector housing having a contact-making region, in which the fit-on regions of the contact elements are mounted in fit-on shafts formed by chamber webs that are adjacent to the side edges of the contact elements and extend perpendicularly to the base plates, the shafts being open rearward above the spring arms and below the base plate.

32-36. (canceled)

37. A method for producing an electric contact element as claimed in claim 31, wherein the plug connector housing is pre-equipped with electric contact elements, the flat conductor is pushed by its free end edge into the free plug-in gap as far as a boundary edge of the plug connector housing and between the open spring arms and the base plate of the contact elements, and in that the spring arms are subsequently fitted to the flat conductor preferably in one work cycle in the plug connector housing.

38. The method as claimed in claim 37, wherein the fitting is effected by means of a fit-on tool which descends into the shafts from above and moves downward against the spring arms and moves the spring arms in the direction of an abutment of the fit-on tool that projects into the shafts from below, an abutment supporting the base plate when the flat conductor is fitted to the fit-on region of the contact element.

39. The contact element as claimed in claim 1, wherein it is fitted to a flat conductor, a first portion of the contact tongues crossing a second portion of the contact tongues, penetrating insulation material and establishing contact at the surface of a conductor track or in a manner sunk somewhat in the material in the surface region of the conductor track.

40. The contact element as claimed in claim 1, wherein it is fitted to a flat conductor, the contact tongues on one side and the contact tongues on the other side of the conductor track, in a manner penetrating the insulation material, establishing contact at the surface of the conductor track or in a manner sunk somewhat in the surface region.
